(19) United States
(12) Patent Application Publication
(10) Pub. No.: US 2010/0057414 A1
(43) Pub. Date: Mar. 4, 2010

(54) Three Dimensional Geomorphic Simulation

(76) Inventor: James Burbeck, Irvine, CA (US)

Correspondence Address: James Burbeck, P.O. Box 14881, Irvine, CA, 92623, US

(21) Appl. No.: 12/199,481

(22) Filed: Aug. 27, 2008

(51) Int. Cl. G06G 7/48

(52) U.S. Cl. 703/6

(57) ABSTRACT

A three dimensional geomorphic simulation is constructed from an array of modular components of standardized form. Said components may also support insertable sub-units which host features of enhanced local relief such as rivers, canals, berms or foundations.

### BACKGROUND OF THE INVENTION

This invention relates generally to the three dimensional presentation of a simulated geomorphic zone. Such presentations are often employed as scale replicas of areas with varying topographical relief which may be real or hypothetical in their context. Previous such devices have not allowed expression of geomorphically realistic topography with the same degree of utility and accuracy as the present invention which articulates slopes, ridges and peaks in a manner which is both realistic and amenable to reduced scale applications. Aforementioned applications include—but are not limited to: Land use presentations, architectural planning, real estate planning and simulations employing reduced scale miniatures.

### SUMMARY OF THE PRESENT INVENTION

The means employed by the present invention to depict a scale topographical zone utilizes an array of numerous three dimensional components. Said components have like profiles which accommodate a wide variety of tiling options, the combined effect of which enables the creation of a scale surface of varied regional topographical relief. The aforementioned components are configured with vertical sides at standardized rotational angles in order to assure full engagement with abutted components.

Certain components additionally contain standardized sectional cavities which can accommodate inserts, the top surface of which may contain reduced scale representations of various features including, but not limited to: Rivers, canals, berms, embankments, roads, highways, foundations, and other related features of local relief.

### BRIEF DESCRIPTION OF THE DRAWINGS

FIG. 1 is an isometric view of a basic planar component.

FIG. 2 is an isometric view of an angled component.

FIG. 3 is an isometric view of a basic component containing a linear cavity.

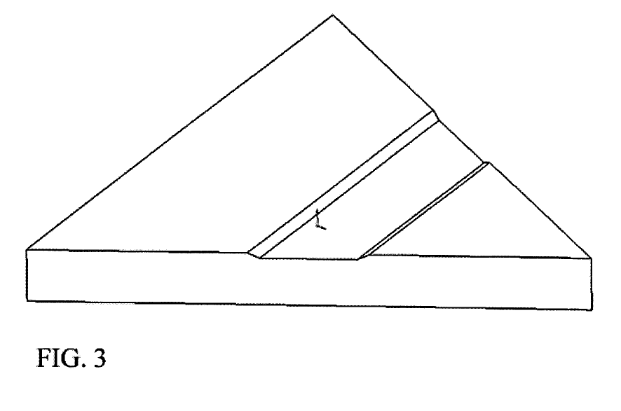

FIG. 4 is an isometric view of a basic component containing a radial cavity.

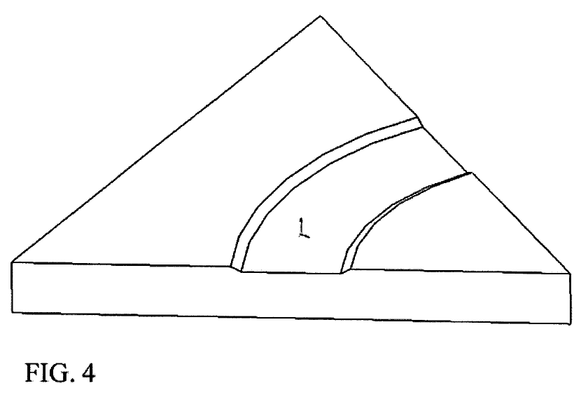

FIG. 5 is an isometric view of a basic component containing a triform cavity.

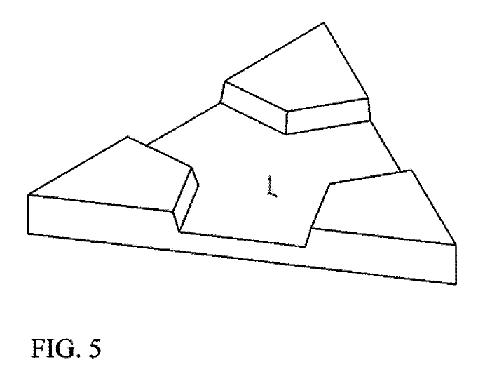

FIG. 6 is an isometric view of a generic triform cavity insert.

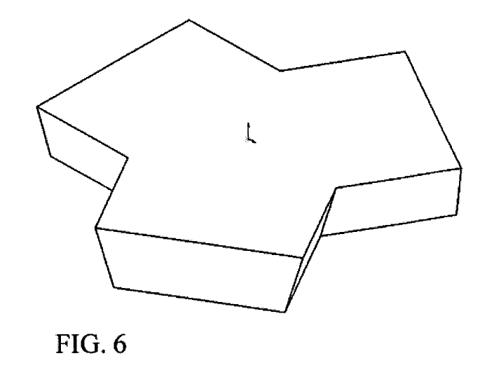

FIG. 7 is an isometric view of a typical topographic simulation.

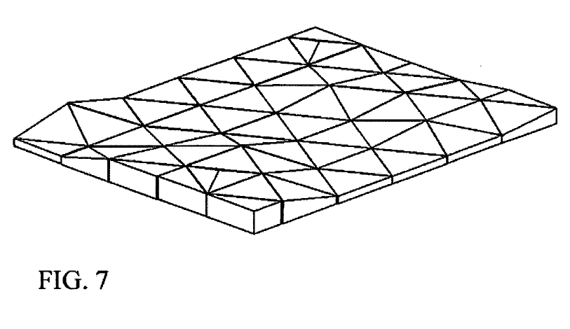

FIG. 8 is an exploded section of FIG. 8.

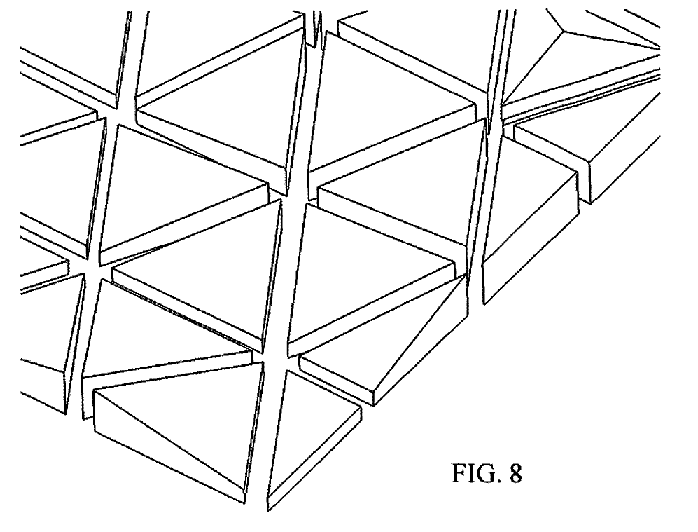

### DETAILED DESCRIPTION OF THE PREFERRED EMBODIMENTS

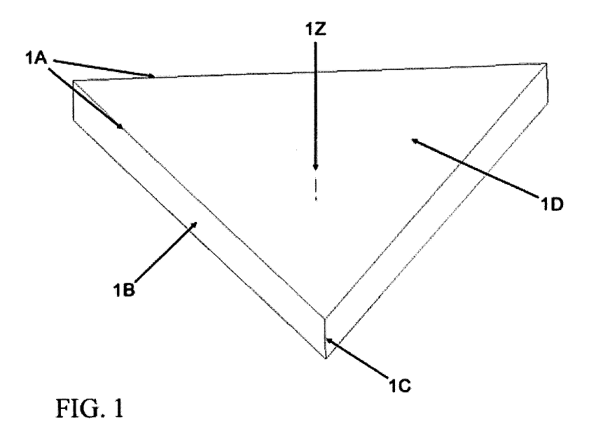

FIG. 1 identifies a three-dimensional polygonal component of triangular form. Edge 1A describes the circumference of the component, which is of standardized form to allow abutment with adjoining components. Line 1Z marks the vertical centerline of the component. Surface 1B indicates one of three vertical side planes which are positioned at 120 degree rotational increments around the corresponding centerline axis of the component. The side planes are parallel to the vertical centerline axis and perpendicular to the lower plane. The upper plane (1D) and lower plane of the component are both flat and parallel, co-located perpendicularly to the aforementioned vertical centerline axis. Line 1C indicates one of three corners which are created at the tangent lines of each pair of side planes.

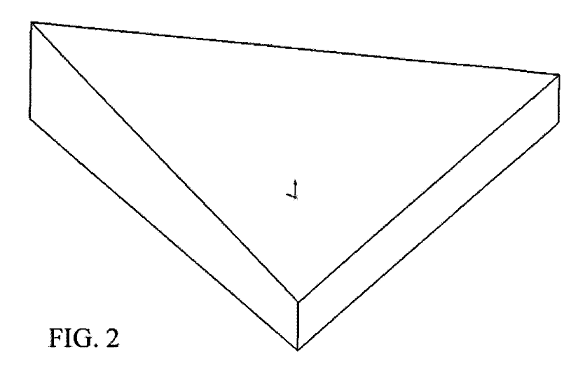

A second item identified with FIG. 2 depicts a triangular component in which the tangent lines at the corners are of different lengths, having the effect of placing the upper plane at an angle to the lower plane. The lower plane remains perpendicular to the vertical centerline axis. All three side planes remain perpendicular to the lower plane.

It can be noted that by varying the angle of the aforementioned upper plane at standardized increments, a wide variety of angled components can be created which will abut in a manner that allows the creation of contiguous upper surfaces of varying relief. Said surfaces many be individually or collectively coated and/or surfaced with a variety of materials or compounds in order to aid in the simulation of the desired features.

Accordingly a vastly improved system for the creation of a three dimensional geomorphic simulation to meet the contemporary needs of planners and simulation technicians. The key embodiments of the invention may be modified by those skilled in the art without exceeding the scope and spirit of the appended claims.

It is claimed: A simulation of regional geomorphology comprising:

1. Three dimensional components with vertical sides of standard outline for abutment with adjoining components of like configuration. Top and bottom planes of said components are flat and parallel at standardized thicknesses in order to assure contiguous abutment with aforementioned adjoining components.

2. Components according to claim 1, wherein the top plane is inclined at a specific angle.

3. Components according to claim 1, wherein the top plane is bisected by a linear cavity.

4. Components according to claim 1, wherein the top plane is bisected by a radial cavity.

5. Components according to claim 1, wherein the top plane is bisected with a cavity composed of branched linear elements, with said elements sharing a common point of origin and oriented perpendicularly to the component sides.

6. Component according to claim 5 wherein said cavity contains a detachable, unsecured insert with a top plane containing edges that are contiguous with the corresponding upper edge of the adjoining component cavity.

7. Component according to claim 6 wherein the top plane of said insert contains a positive-relief feature integrally molded and/or permanently affixed. Component according to claim 6 wherein the top plane of said insert contains a negative-relief feature molded and/or permanently affixed.
